(19) United States
(12) Patent Application Publication
(10) Pub. No.: US 2004/0238534 A1
(43) Pub. Date: Dec. 2, 2004

(54) Package for microwave cooking

(76) Inventor: Roy Lee Mast, Plano, TX (US)

Correspondence Address: ERIC B. MEYERTONS, MEYERTONS, HOOD, KIVLIN, KOWERT & GOETZEL, P.C., P.O. BOX 398, AUSTIN, TX, 78767-0398, US

(21) Appl. No.: 10/447,666

(22) Filed: May 29, 2003

(51) Int. Cl. H05B 6/80

(52) U.S. Cl. 219/730

(57) ABSTRACT

A microwavable package may include one or more microwave-absorbing regions, microwave-shielding regions, and/or embossed regions designed to enhance microwave cooking of food products including raw meat, poultry, and fish as well as breaded, battered, and dough containing items. Microwave-absorbing regions (i.e., solid susceptors) may promote thermal cooking, browning, and/or crisping of food products. Microwave-shielding regions (i.e., patterned susceptors) may promote uniform cooking and inhibit overcooking of food products. A patterned susceptor may be a conductive grid or a grid of conductive or non-conductive shapes (e.g., squares, triangles, circles). In an embodiment, solid susceptors and patterned susceptors may be formed from a common thin metal film on a common polymer barrier layer and laminated to a common structural backing layer. An embossed region of a microwavable package may promote crisping of a food product by allowing air to circulate between the food product and an interior surface of the microwavable package.

### BACKGROUND

1. Field of the Invention

The present invention generally relates to microwavable packages. In particular, the present invention relates to packages for use in microwave cooking of food products, including raw meat, poultry, and fish; and battered, breaded, and dough-containing items. Microwave-absorbing regions and microwave-shielding regions of the packages are designed to achieve crisping, browning, and/or uniform cooking of various food products.

2. Description of Related Art

Microwave cooking offers a quick, energy-efficient alternative to conventional oven or stove-top cooking. For certain food types, however, a desired outcome may be difficult to achieve with microwave cooking. Microwave cooking of food products, including meat and/or battered, breaded, or dough-containing items (e.g., pastries, pizza, sandwiches, breaded chicken pieces, batter-coated fish products, whole chickens, beef or pork roasts, steaks), may result in overcooked, undercooked, dry, and/or soggy regions of the product.

Microwave packaging has been designed to address some of the problems associated with microwave heating of certain types of foods, including foods that are desirably browned or crisped. Microwave packaging may include heavy metal, metallic foil, and/or metallic film to enhance crisping, browning, and/or uniform heating of a food item by selectively shielding and/or absorbing microwave energy. Absorbed microwave energy may be converted to thermal energy for conductive and/or radiative heating of a food product.

U.S. Pat. No. 6,501,059 to Mast, which is incorporated by reference as if fully set forth herein, describes microwave packaging including a heavy metal layer disposed between a structural layer and a polymer barrier layer. The heavy metal layer is designed to selectively absorb microwave energy and/or shield the packaged food from fill exposure to the microwave energy. UK Patent Application No. 2,211,380 of Mitchell et al. describes a flexible package for microwave cooking. The package may be in the form of a pouch envelope or bag made from flexible stock. Aluminum foil within the package allows for browning and/or crisping of food items, such as pizza. International Application No. PCT/EP00/10683 of Mast describes a package including a box and a microwave susceptor for cooking a food item using microwaves.

### SUMMARY

A microwavable package may include one or more microwave-absorbing regions, microwave-shielding regions, and/or embossed regions designed to enhance microwave cooking of food products including raw meat, poultry, and fish as well as breaded, battered, and dough-containing items. Microwave-absorbing regions (i.e., solid susceptors) may promote thermal cooking, browning, and/or crisping of food products. Microwave-shielding regions (i.e., patterned susceptors) may promote uniform cooking and inhibit overcooking of food products. An embossed region (e.g., base) of a microwavable package may promote crisping of a food product by allowing air to circulate between the food product and an interior surface of the microwavable package.

A solid susceptor may be formed by depositing a thin metal film onto a polymer barrier layer and laminating the metallized polymer barrier layer to a structural backing layer. In some embodiments, a patterned susceptor may be formed by selectively demetallizing a metallized polymer barrier layer before lamination. In other embodiments, a patterned susceptor may be formed by masking a portion of a polymer barrier, vacuum depositing metal on the polymer barrier, and removing the mask to leave a patterned susceptor having a desired metallized pattern.

Patterned susceptors may be designed to achieve desired absorbance and/or transmittance of incident microwave energy. In an embodiment, a patterned susceptor may be a conductive grid. In other embodiments, patterned susceptors may include conductive or non-conductive shapes (e.g., squares, triangles, circles). In an embodiment, solid susceptors and patterned susceptors may be formed from a common thin metal film on a common polymer barrier layer and laminated to a common structural backing layer.

A microwavable package may be of any shape, size, design, or construction known in the art. In an embodiment, a microwavable package may have a base member and a lid member. The base member and the lid member may overlap such that a food product may be sealed inside the microwavable package. In some embodiments, a sealed microwavable package may allow a pressure greater than atmospheric pressure to build up during cooking such that gases and moisture evolved from the food product promote thermal cooking and moisture retention in the food product. In other embodiments, a sealed microwavable package may vent at atmospheric pressure to enhance crisping of dry food products (e.g., breaded chicken pieces, battered fish pieces, French fries) and baking of dough-containing items (e.g., cinnamon rolls, pastries, biscuits, bread sticks).

A food product may substantially fill the volume of a microwavable package. Susceptors and embossed regions in a microwavable package may be designed to enhance cooking of an intended food product. Interior surfaces of a microwavable package may include any combination of solid and/or patterned susceptors necessary to achieve desired cooking results. In some embodiments, a base and a lid of a microwavable package may include solid susceptors, while sides and/or flaps of a microwavable package may include patterned susceptors (e.g., conductive grids). In certain embodiments, all interior surfaces of a microwavable package may include patterned susceptors (e.g., conductive squares). In an embodiment, susceptor location is designed to inhibit arcing from one interior surface of a microwavable package to another.

In certain embodiments, a microwavable package may have an embossed base to allow airflow beneath the food product and enhance cooking of a food product placed on the embossed base. An embossed solid susceptor base may be used to crisp food products (e.g., French fries, and chicken nuggets). A microwavable package with an embossed solid susceptor base may include any combination of solid and/or patterned susceptors on other interior surfaces of the microwavable package. In some embodiments, the embossing may include two or more embossed layers to increase elevation of the food product from the base of the microwavable package. The embossing may include any size and/or shape known in the art.

In some embodiments, a shelf life of a food product may be extended by placing a microwavable package containing a food product in a sealable microwavable container and flushing the sealable microwavable container with inert gas (e.g, nitrogen). The sealable microwavable container may be of any size, shape, or construction known in the art. In certain embodiments, a sealable microwavable container may include two or more components (e.g., a base and a lid). In other embodiments, a sealable microwavable container may include a single hinged component. In an embodiment, the microwavable container may be sealed with a thin plastic film to be removed during use.

### BRIEF DESCRIPTION OF THE DRAWINGS

Advantages of the present invention will become apparent to those skilled in the art with the benefit of the following detailed description of embodiments and upon reference to the accompanying drawings in which:

FIG. 1 depicts a patterned susceptor.

FIG. 2 depicts a patterned susceptor.

FIG. 3 depicts a patterned susceptor.

FIG. 4 depicts a patterned susceptor.

FIG. 5 depicts a top view of an embodiment of a pre-assembly microwavable package.

FIG. 6 depicts a perspective view of the microwavable package in FIG. 5 after assembly.

FIG. 7 depicts a perspective view of the microwavable package in FIG. 6 after sealing.

FIG. 8 depicts a perspective view of an embodiment of a microwavable package.

FIG. 9 depicts a perspective view of the microwavable package in FIG. 8 after sealing.

FIG. 10 depicts a perspective view of an embodiment of a microwavable package.

FIG. 11 depicts a perspective view of an embodiment of a microwavable package with an embossed base.

FIG. 12 depicts a cross-sectional view of a portion of the embossed base shown in FIG. 11.

FIG. 13 depicts a perspective view of an embodiment of an embossed inset.

FIG. 14 depicts a perspective view of an embodiment of a sealable container.

FIG. 15 depicts a perspective view of an embodiment of a sealable container.

While the invention may be susceptible to various modifications and alternative forms, specific embodiments thereof are shown by way of example in the drawings and will herein be described in detail. The drawings may not be to scale. It should be understood, however, that the drawings and detailed description are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF EMBODIMENTS

Microwave-shielding or microwave-absorbing regions may be used in microwave food packaging to tailor microwave cooking of food products. As used herein, the term “cooking” generally refers to cooking a food product from a raw state to an edible state, partial cooking, heating, and/or reheating. Microwave-shielding regions may shield a food product from dielectric and/or thermal heating. Shielding a food product from dielectric and/or thermal heating may inhibit overcooking and/ or uneven cooking of the food product. Microwave-absorbing regions may include conductive materials that undergo heating when exposed to microwave radiation. Heat from a microwave-absorbing region may be used to cook a food product thermally with conductive and/or radiative heat. Thermal cooking of a food product may promote characteristics associated with conventional cooking, such as browning, crisping, and uniform cooking of the food product.

When exposed to microwave radiation, a microwave-absorbing layer formed from a thin metal film absorbs a portion of microwave energy. The thin metal film may undergo resistive (ohmic) heating due to the electrical currents induced within the metal layer by the microwave radiation. As used herein, “thin metal film” generally refers to a metal film with an optical density of about 0.10 to about 0.70. A thin metal film may be characterized by a sheet resistance of about 20 to about 500 ohms per square of the material (ohms/square). Thickness of thin metal films is commonly specified in terms of optical density. Optical density typically increases with metal thickness. For aluminum, a sheet resistance between about 20 and about 500 ohms/square may correspond to an optical density of about 0.10 to about 0.70. Sheet resistance typically varies inversely with optical density (i.e., thickness).

Microwave-absorbing material may be incorporated into microwave packaging by depositing a thin metal film onto a polymer barrier layer. The resulting metallized polymer barrier layer may then be laminated (i.e., affixed) to a structural backing layer. Lamination of the metallized polymer barrier layer may inhibit contact between the metal film and a food product contained by the packaging. The laminate (i.e., metallized polymer barrier layer affixed to the structural backing layer) may be used to form a solid susceptor for microwavable packaging for food products. As used herein, the term “solid susceptor” refers to a conventional microwave susceptor, i.e., a thin metal film laminated to a structural backing layer.

Microwave-absorbing material in the form of a solid susceptor may undergo non-uniform heating when exposed to microwave radiation. Non-uniform heating may cause some regions of a food product to be undercooked and other regions to be overcooked. Non-uniform heating may result inherently from the solid susceptor itself, from microwave oven hot spots corresponding to regions of greater microwave intensity, or from non-uniform contact of the food product with the solid susceptor. In addition, a solid susceptor may overheat, become damaged, and/or cease to function as desired. Susceptor overheating may be accompanied by shrinkage of the polymer layer or layers. Shrinkage may lead to cracking (crazing) of the metallic layer and/or arcing. As a result, the susceptor may become less absorbing and more transmitting to microwave radiation. A food product may receive a greater amount of conventional dielectric heating than desired.

Selective demetallization of a thin metal film may be used to form a patterned susceptor. A patterned susceptor of a given area may absorb less microwave energy, and therefore generate less heat, than a solid susceptor of the same area. Thus, a patterned susceptor may be designed to limit the amount of heating in a region of a microwavable package. Another patterning approach entails disrupting rather than demetallizing a thin metal film. A number of techniques have been used to provide desired patterning of metal films. Some of these techniques are described in U.S. Pat. No. 5,614,259 to Yang et al.; U.S. Pat. No. 4,959,120 to Wilson; U.S. Pat. No. 4,685,997 to Beckett; 4,610,755 to Beckett; and U.S. Pat. No. 4,552,614 to Beckett, each of which is incorporated by reference as if fully set forth herein.

A solid susceptor of given dimensions may absorb more microwave radiation, and thus generate more heat energy, than a patterned susceptor of the same dimensions made of the same material. Thus, a patterned susceptor may be characterized by an effective electrical sheet resistance less than that of a solid susceptor. In an embodiment, microwave-absorbing and microwave-shielding regions may be achieved in a microwavable package fabricated with a solid thin metal film of a single thickness by selective patterning of regions of the package. A variety of metal films including, but not limited to, aluminum, nickel, iron, tungsten, copper, chromium, stainless steel alloys, nickel-chromium alloys, Nichrome, and Inconel may be used to form solid and patterned susceptors.

A solid susceptor may be fabricated by depositing a thin metal film onto a barrier layer, drying the metallized barrier layer, and laminating (i.e., adhering) the metallized barrier layer to a structural backing layer. A polymer barrier layer may include, but is not limited to, polyesters, polyimides, polyamides, polyethers, cellophanes, polyolefins, polysulfones, ketones, polyethylene terephthalate (PET), and polyethylene naphthalate. A polymer barrier layer may range in thickness from about 0.005 mm (0.2 mil) to about 0.05 mm (2.0 mil) but is not limited to this range. In an embodiment, the polymer barrier layer may have about a 0.013 mm thickness. Deposition techniques may include, but are not limited to, vacuum deposition, sputtering, chemical vapor deposition, and solution plating including electro-deposition and electroless deposition. Lamination may be achieved with any equipment and/or material (e.g., adhesive) known in the art. A structural backing layer may include, but is not limited to, various thicknesses of food grade paper, food grade paperboard, and/or polymers.

A metallized barrier layer may be selectively demetallized to form a patterned susceptor. Droplets of liquid etchant, such as sodium hydroxide (NaOH), may be deposited on the thin metal film in a desired pattern. The etchant may be deposited by printing techniques including, but not limited to, flexographic printing, gravure printing, dot matrix printing, line screening, and half-tone printing. After rinsing the metallized polymer barrier layer to remove the etch product, an electrically conducting microwave-absorbing region having the desired pattern may remain. Alternatively, an etch-resistant masking material may be deposited by any suitable method, including methods listed above. After deposition of the metal layer, the masking material may be removed. The metallized and patterned polymer barrier layer may be subsequently dried and laminated to a structural backing layer to complete the patterned susceptor.

A patterned susceptor may achieve a desired percentage of microwave reflectance and/or transmittance. The patterned susceptor may function as an effective microwave and/or thermal shield. In an embodiment, a patterned susceptor may include a grid of conductive lines disposed perpendicularly to each other. Square non-conductive regions disposed in the pattern may separate thin metal film grid lines. In a microwavable package embodiment, a square grid pattern characterized by a grid line width w and a center-to-center separation distance of squares d may be designed to reflect and/or transmit a desired percentage of incident microwave radiation.

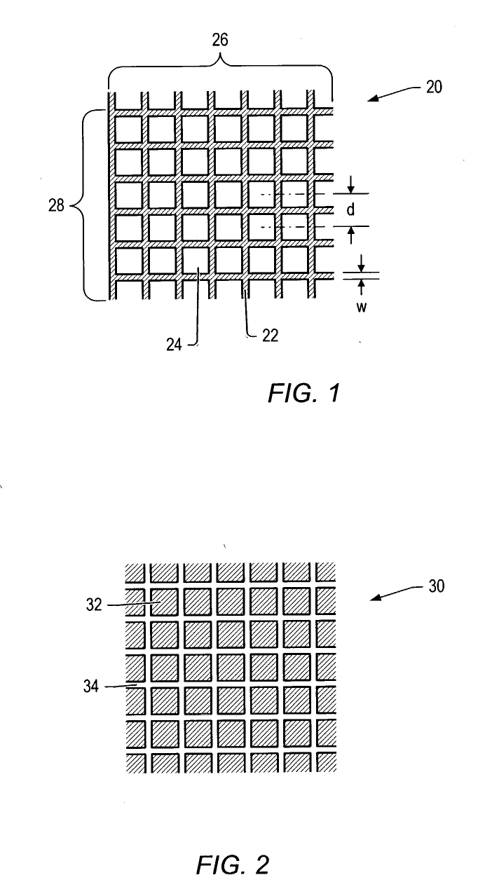

A patterned susceptor in the form of a conductive grid may intercept electromagnetic energy (e.g., at a frequency of 2.46 GHz) if the center-to-center separation distance (d) of adjacent conductive islands or formations is approximately 1 cm or less. FIG. 1 depicts patterned susceptor 20 in the form of a square grid. In an embodiment, patterned susceptor 20 may be fabricated from aluminum film with an optical density of 0.26. Conductive lines 22 may form a grid with w=1.0 mm and separation distance d=2.5 mm between non-conductive squares 24. Patterned susceptor 20 may reflect about 53% of incident microwave radiation, transmit about 5% of incident microwave radiation, and absorb about 42% of incident microwave radiation.

Width w and/or distance d of a square grid may be chosen for a region of a microwavable package to achieve a desired cooking result of a food product. In certain embodiments, a patterned susceptor grid may be a rectangular grid of various dimensions. In other embodiments, a grid may be an irregular grid with non-uniform values of w and/or d. Patterned susceptor 20 may have open grid edges 26 and/or closed grid edges 28. A patterned susceptor with closed grid edges may provide more effective microwave and/or thermal shielding than a patterned susceptor with open grid edges.

FIG. 2 depicts an embodiment of patterned susceptor 30 in the form of square conductive regions 32 separated by a grid of non-conductive lines 34 disposed perpendicularly to each other. In other embodiments, patterned susceptors are not limited to squares and grids. Selective demetallization of a thin metal film may be carried out in various patterns to reduce cross-sectional areas of individual conductive paths, thereby decreasing an effective sheet resistance of the thin metal film.

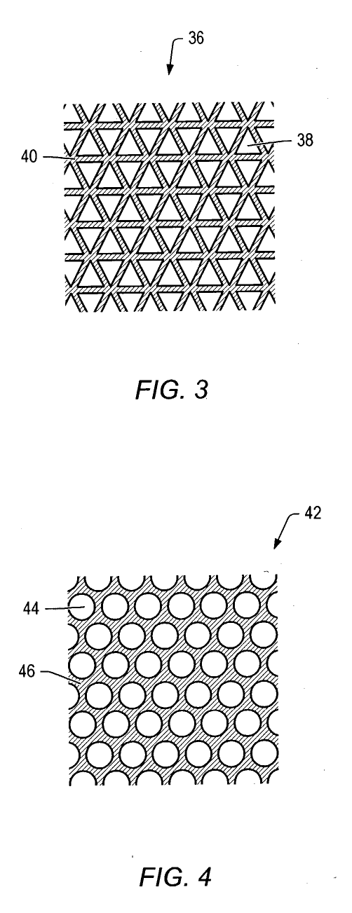

Patterned susceptor 36 shown in FIG. 3 is characterized by an array of equally spaced non-conductive triangular areas 38. Areas 38 are separated by interconnected grid lines 40. Grid lines 40 may be disposed at angles of approximately 60 degrees relative to each other to form a conductive triangular grid. Patterned susceptor 42 shown in FIG. 4 shows an array of equally spaced non-conductive circular regions 44. Non-conductive regions 44 may be separated by a continuous matrix of thin metal film 46. In certain embodiments, demetallization may be irregular. Closely spaced voids with a predetermined range of sizes in random locations may provide decreased effective sheet resistance and thus effective microwave shielding.

During use, regions in a patterned susceptor (e.g., grid lines) may be exposed to abnormally high levels of microwave energy due to “hot spots” within a microwave oven. Patterned susceptors may be designed to limit crazing and/or arcing caused by microwave hot spots. Conductive grid lines in a patterned susceptor heat up rapidly, thereby rapidly heating adjacent polymeric laminate. The laminate may exceed its extrusion temperature, causing rapid shrinkage that may break one or more adjacent grid lines. This isolated break stops the heating process of the isolated portion of the grid, but does not stop the remainder of the grid from undergoing resistive heating, thereby avoiding further damage and/or arcing in the thin metal film layer. Thus, intersecting grid lines in a patterned susceptor may act as individual fuses, which can “blow” in a localized region while intact regions of the patterned susceptor function normally.

In an embodiment, solid and/or patterned susceptors may substantially cover the interior surfaces of a microwavable package. When the package is sealed, the susceptors may substantially surround a food product contained in the package to achieve desired cooking (e.g., temperature, texture, moisture level) of the food product during use. Some food products require more heating (or higher temperatures) than other food products. The arrangement of solid and/or patterned susceptors may be determined by the intended use of the package (i.e., on the food product that is intended to be sealed in the package).

A microwavable package may be of any size, shape, configuration, or construction known in the art. In certain embodiments, a microwavable package may be designed to accommodate a general shape of an intended food product. A close fit to the food product and a tight seal may be desirable. In an embodiment, a microwavable package may be formed of single piece construction. In other embodiments, a microwavable package may include two or more separate components. In some embodiments, a microwavable package may be designed so that a food product in the microwavable package contacts or is close to sides of the food package adjacent to the food product. In some embodiments, the food product may rest on a bottom of the microwavable package. Sides of the food product may contact or be less than about 0.7 cm from side walls of the microwavable package. A top of the food product may contact or be less than about 0.7 cm from a top of the microwavable package.

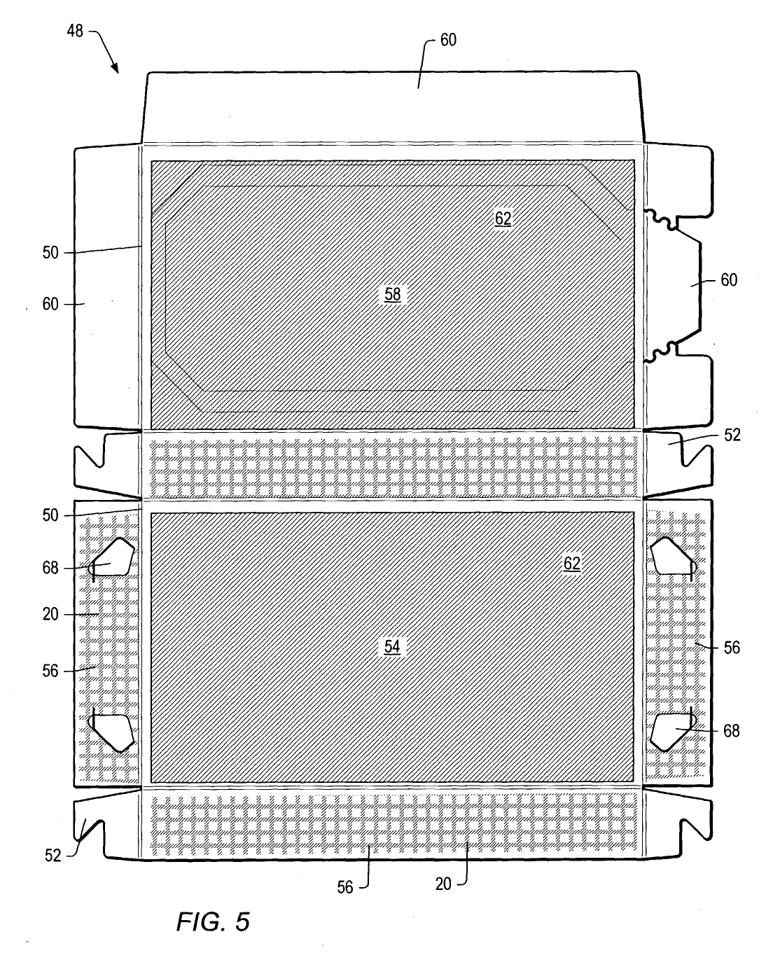

FIG. 5 depicts a pre-assembly microwavable package of single piece construction. Microwavable package 48 may include a series of stamped folding lines 50 and joining tabs 52 that allow the package to be folded into its final assembled shape and bonded using food grade adhesive (e.g., WC 3458 3M, St. Paul, Minn.). Microwavable package 48 includes base 54, sides 56, lid 58, and flaps 60. Solid susceptors 62 are shown on base 54 and lid 58. Patterned susceptors 20 are shown on sides 56. During use, solid susceptors 62 promote browning and thermal cooking of a food product contained in microwavable package 48. Patterned susceptors 20 may shield a portion of incident microwave energy, thereby inhibiting overcooking of side edges of the food product. In an embodiment, microwavable package 48 may be used to cook food products including, but not limited to, steaks, fish filets, chicken breasts, and pork chops.

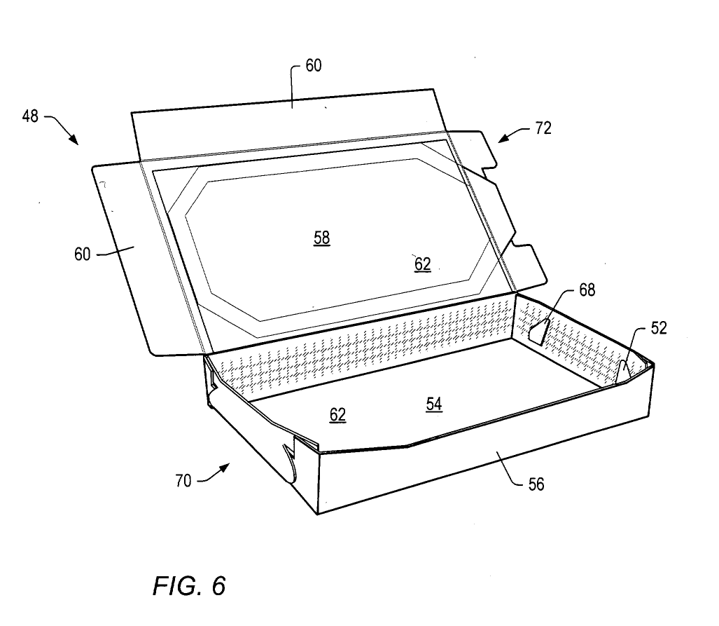

To reduce occurrence of unwanted heat build up and/or fire during cooking, a microwavable package may be designed to avoid overlap of susceptors when a package is in use. For example, pre-assembly microwavable package 48 shown in FIG. 5 may have a plurality of tabs 52 which, when the package is assembled, are fixed to adjacent sides 56. Each tab 52 and corresponding side 56 may include patterned susceptor 20. Patterned susceptors 20 on each side 56 may have non-metallized or blank region 68. A shape of blank region 68 may correspond to a shape of tab 52. Thus, when package 48 is assembled as shown in FIG. 6, each tab 52 fits into corresponding blank region 68 such that no overlap of susceptor material occurs.

The cutting, stamping, folding, and bonding of a microwavable package may be accomplished using conventional packaging techniques after solid and/or patterned susceptors have been laminated on the structural backing layer. Thin metal film may be used to form solid susceptors (i.e., microwave-absorbing regions) as well as patterned susceptors (microwave-shielding regions). Use of a single metal film thickness may simplify package fabrication by allowing a single type of structural backing layer and a single type of laminate to be used. Therefore, a microwavable package with microwave-absorbing and/or microwave-shielding regions (i.e., solid and patterned susceptors) may be formed from the same structural backing layer and/or laminate in a one-step process, followed by stamping, cutting, and/or folding steps to form a microwavable package with desired characteristics.

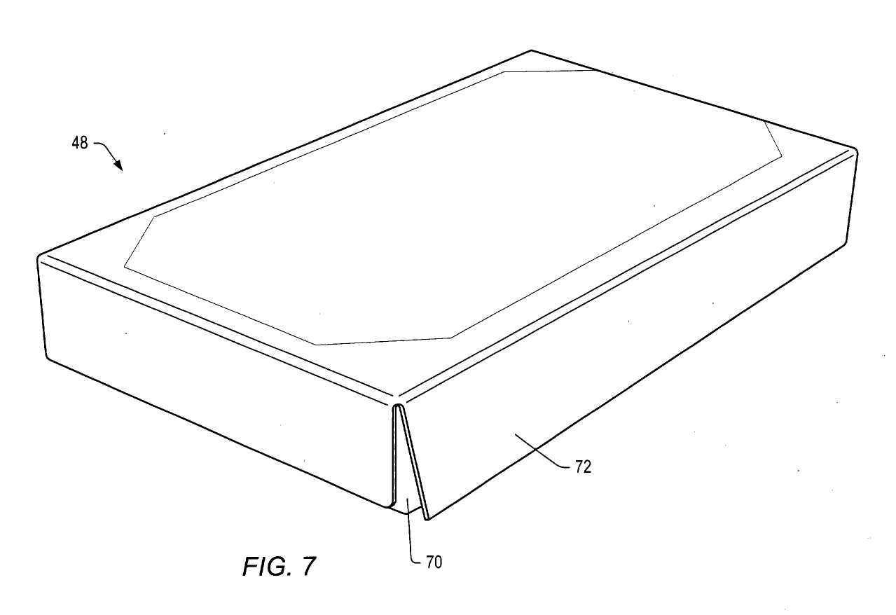

Base member 70 of microwavable package 48 shown in FIG. 6 may include base 54 and sides 56. Lid member 72 of microwavable package 48 may include lid 58 and flaps 60. Lid 58 may be substantially flat. In some embodiments, base 54 and lid 58 include solid susceptors 62. In other embodiments, base 54 and/or lid 58 may include a patterned susceptor. As shown in FIG. 7, base member 70 and lid member 72 may overlap when closed together to form a seal around at least part of the interface between the base member and the lid member. Base member 70 and lid member 72 may be fastened together using fastening methods including, but not limited to, adhesive, locking flap or flaps, and/or complementary fastening members on the base member and the lid member. Complementary fastening members may engage in a conventional manner to hold microwavable package 48 closed.

In an embodiment, a lid member fastened to a base member may allow pressure within a microwavable package to be maintained above atmospheric pressure. In an embodiment, food grade adhesive used to seal a microwavable package may soften during use. Overlapping portions of the base member and the lid member may then be forced apart by pressure that builds up during cooking. A package design that allows pressure to be released may be used to regulate the amount of pressure that is allowed to build up within the sealed package.

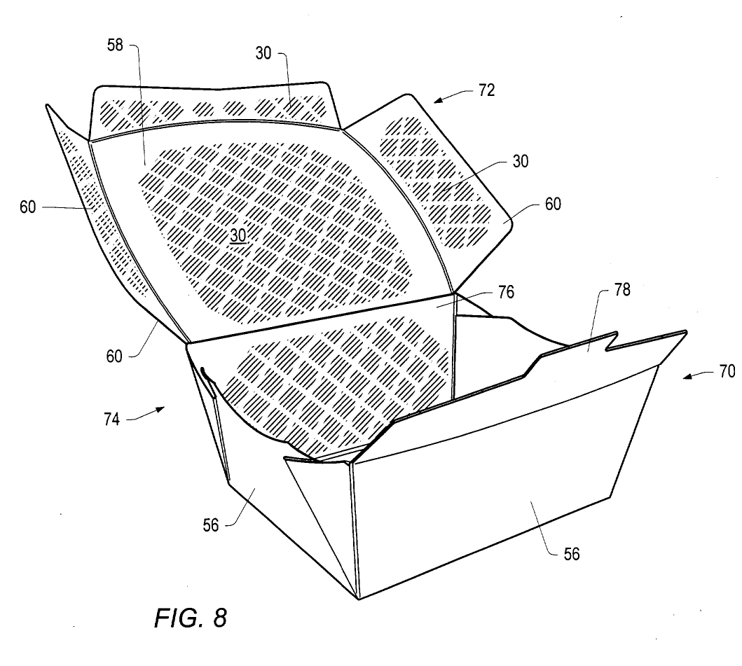

FIG. 8 depicts an embodiment of a microwavable package. Sides 56, lid 58, and flaps 60 of microwavable package 74 may include patterned susceptors 30 in the form of a grid of conductive squares. The base of microwavable package 74 may include a solid susceptor, patterned susceptor, or an embossed susceptor. In some microwavable package embodiments, the flaps, sides, and lid of a microwavable package may include any non-overlapping combination of solid and/or patterned susceptors designed to achieve a desired cooking result.

In an embodiment, solid/and or patterned susceptors are advantageously positioned within a microwavable package such that arcing does not occur between interior surfaces of the package. Inhibiting arcing may be achieved by designing susceptor location such that conduction and/or induction is inhibited between susceptors on adjacent surfaces of a package. In an embodiment, patterned susceptors may be located on interior side surfaces to inhibit arcing from one side to another and/or from a lid member or base member to a side. In certain embodiments, interior corners 76 of microwavable package 74 may be substantially blank (void of susceptor material), thereby inhibiting arcing in the corners. Blank interior corners may advantageously inhibit crazing, cracking, arcing and/or fire. Blank interior corners may also inhibit overcooking of food in corner regions of the package.

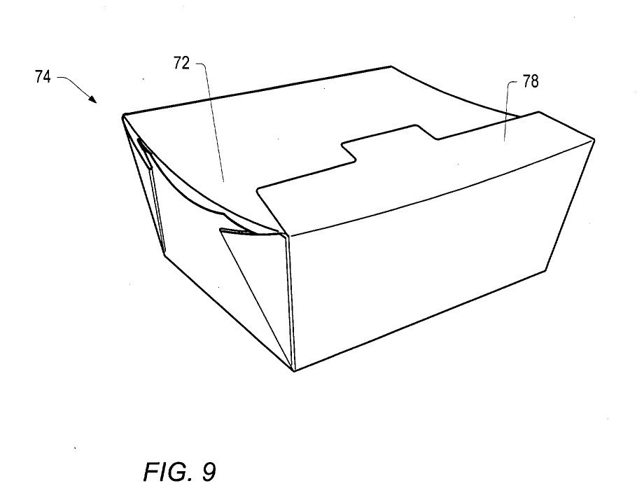

Microwavable package 74 may have hinged arcuate lid member 72 with flaps 60. Microwavable package 74 may be sealed by inserting flaps 60 within sides 56 of base member 70 and folding locking flap 78 over lid member 72. Locking flap 78 is configured to hold lid member 72 in place, as shown in FIG. 9. Locking flap 78 may be sealed to lid member 72. In certain embodiments, microwavable package 74 may be used to cook food products including, but not limited to, raw meat (e.g., a beef or pork roast) or poultry (e.g., a whole chicken). A solid susceptor in the base of microwavable package 74 may promote browning of a surface of the meat. Patterned susceptors may serve as a partial microwave and/or thermal shield, contributing less heat energy per area than solid susceptor.

Advantageously, a microwavable package may be designed to enclose a food item during use such that hot gases and steam may be retained above atmospheric pressure within the package during a cooking process. The heat and elevated pressure caused by hot gases and steam may assist in the cooking of the food item. To inhibit sudden release of pressure from the package, the package may be designed such that upon buildup of pressure to a predetermined level, at least some of the gases and steam are permitted to escape to relieve pressure buildup. Relief of pressure buildup may be achieved by, for example, forming perforations in the package that retain the steam and gas below the predetermined pressure or by shaping the package such that small gaps are formed at the seams of the package when closed.

A microwavable package may not necessarily be sealed around its entire periphery. For example, gaps may be formed at corners of the interface between a base member and a lid member (i.e., at upper corners of a package). It is sufficient that only part of the interface is sealed to allow adequate pressure (and also temperature) build up within the package before venting/regulation occurs.

In an embodiment, a microwavable package may be designed to seal contents inside the package. The seal may be achieved with an adhesive or with any locking package construction. A package with a tight seal may promote moisture retention and allow the food product to be thermally cooked with steam and gas evolving from the food product, resulting in desirable food texture and flavor. In an embodiment, a package may be designed to remain sealed with internal pressures above atmospheric pressure. This would be advantageous for some raw meat and poultry products. Alternatively, a package designed for dough or bread-containing products may be designed to vent above atmospheric pressure so the food products do not become soggy.

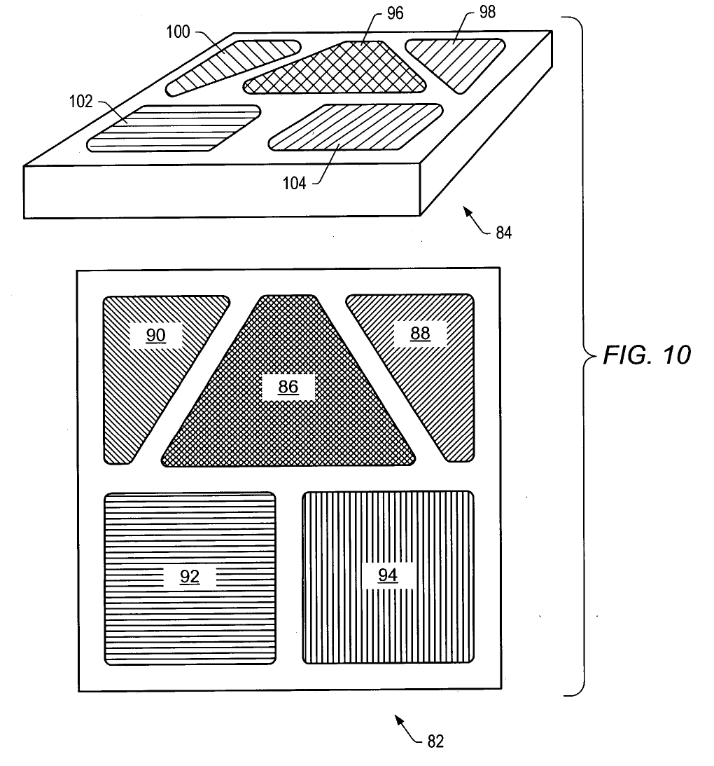

FIG. 10 depicts microwavable package 80 that includes tray 82 and enclosure 84. In an embodiment, tray 82 may have two or more recessed regions for containing food products. In the embodiment shown in FIG. 10, tray 82 has five recessed regions 86, 88, 90, 92, 94 with solid/and or patterned susceptors positioned at a base of each recessed region. Recessed regions 86, 88, 90, 92, 94 of tray 82 may be produced with a conventional stamping apparatus from a laminated structure including the susceptor regions disposed, for example, between a polymer barrier layer and a structural backing layer. Tray 82 and enclosure 84 may be separate components. Alternatively, a single hinged component may include tray 82 and enclosure 84.

Having a variety of susceptors in a single microwavable package may be advantageous in applications that contain different food products with different cooking requirements. For example, frozen meal packages may contain meat in recessed region 86, vegetables in recessed regions 88 and 90, bread in recessed region 92, and dessert in recessed region 94. Tray 82 may be manufactured by placing, for example, solid susceptor 62 in recessed region 86, patterned susceptor 30 in recessed regions 88 and 90, and patterned susceptor 20 in recessed regions 92 and 94.

In an embodiment, tray 82 may be used in conjunction with enclosure 84. Enclosure 84 may be a laminated structure including patterned susceptor (i.e., microwave-shielding) regions disposed between a polymer barrier layer and a structural backing layer. Susceptor regions 96, 98, 100, 102, 104 of enclosure 84 may be positioned to correspond to recessed regions 86, 88, 90, 92, 94, respectively, in tray 82. Susceptor regions 96, 98, 100, 102, 104 may include any combination of solid and/or patterned susceptors to selectively absorb and/or shield microwaves as needed to meet the cooking requirements of food products in recessed regions 86, 88, 90, 92, 94, respectively. For example, susceptor region 96 may include solid susceptor 62 to enhance browning of meat in recessed region 86. Susceptor regions 98, 100, 102, 104 may include patterned susceptors including, but not limited to, patterned susceptors shown in FIGS. 1-4. Microwave shielding in susceptor regions may inhibit dielectic and thermal overheating of food products in associated recessed regions.

In an embodiment, susceptor placement and design may be tailored to cooking requirements of an intended food product for a given microwavable package. In an embodiment, a microwavable package may include solid and/or patterned susceptors. For example, a microwavable package designed for cooking a whole chicken or roast may include a solid susceptor on a base of the package and patterned susceptors on a lid and sides of the package. In a package embodiment for cooking breaded and/or battered chicken or fish pieces, solid susceptors may be located on a lid and base of the package, and patterned susceptors may be located on sides of the package. This allows browning/crisping on the top and bottom of the food product and limits microwave and thermal heating along the sides, thereby preventing overcooking of the edges. Other arrangements of solid and/or patterned susceptors may be chosen to satisfy cooking requirements of various food products.

In preparation for use, a food product to be cooked is placed in a microwavable package. The package lid is then closed so that the food product is wholly contained within the package. In an embodiment, the food product may substantially fill the volume of the microwavable package to promote uniform cooking and enhance texture and moisture characteristics of the cooked food product. For example, a volume of the food product may be greater than 70%, greater than 80%, or greater than 90% of a volume of the package. As needed, the package may be placed into a microwave oven. Upon cooking, moisture, such as steam and natural juices, may evolve from the food product. This is particularly true when the food products are raw meat, poultry, fish, or related items. For raw meat, poultry, fish, or related items, the moisture may help heat the food product and retain desired texture and flavor. For items containing dough, batter, breading, or other items, such as French fries, moisture soaked up by the food product during cooking may produce undesirable texture characteristics.

In an embodiment, a solid and/or patterned susceptor surface of a microwavable package may be embossed. An embossed solid susceptor base may allow a food product placed in the package to be elevated from the base of the package. Elevating the food product from the base of the package may allow air to circulate beneath the food product. Air circulation between the food product and the base may promote crisping of the food product.

Embossed shapes may take any suitable form and may include, for example, a plurality of mutually spaced-apart, stud-like bosses (e.g., rectangular, circular, or polygonal in shape) or a plurality of mutually spaced-apart elongate or ridge-like bosses. In some embodiments, channels may be formed between raised bosses. Alternatively, the bosses may be of an irregular size and/or shape. In some embodiments, boss height may range from about 0.05 mm to about 0.5 mm. For example, a 2 cm×0.75 cm rectangular boss may have a height of about 0.2 mm.

In an embodiment, an embossed shape may be further embossed (double embossed) to provide additional elevation of a food product and promote greater circulation of air underneath the food product. Double embossing may enhance crispness of the cooked food product. The double embossing may be of any regular and/or irregular size and/or shape and may fit within the first layer of embossing. In certain embodiments, a surface of a microwavable package may include three or more embossed layers (e.g, triple embossing). In certain embodiments, a microwavable package may include a combination of features, including various solid and/or patterned susceptors and/or embossing.

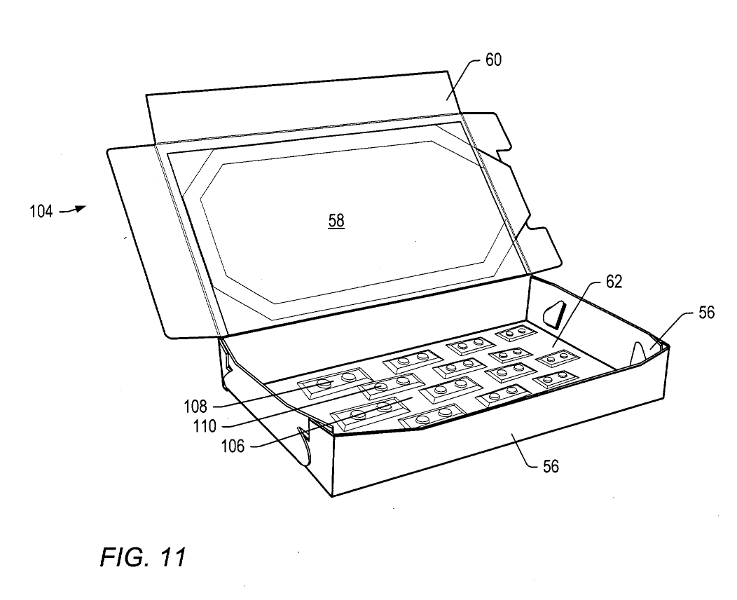

FIG. 11 depicts microwavable package 104 with embossed base 106. Base 106 may include solid susceptor 62. A first embossed layer of base 106 may include first bosses 108. First bosses 108 may be substantially uniform and rectangular in shape in some embodiments. A height of first bosses 108 may range from about 0.05 mm to about 0.5 mm. Some or all of first bosses 108 may include second bosses 110. Second bosses 110 may be substantially uniform and circular in shape in some embodiments. Double embossing may add an additional height of about 0.05 mm to about 0.5 mm (e.g., about 0.2 mm) to the first embossing. A first boss and a second boss may have any desired geometric shape. Bosses may be formed by stamping the bottom of a base with an appropriate form.

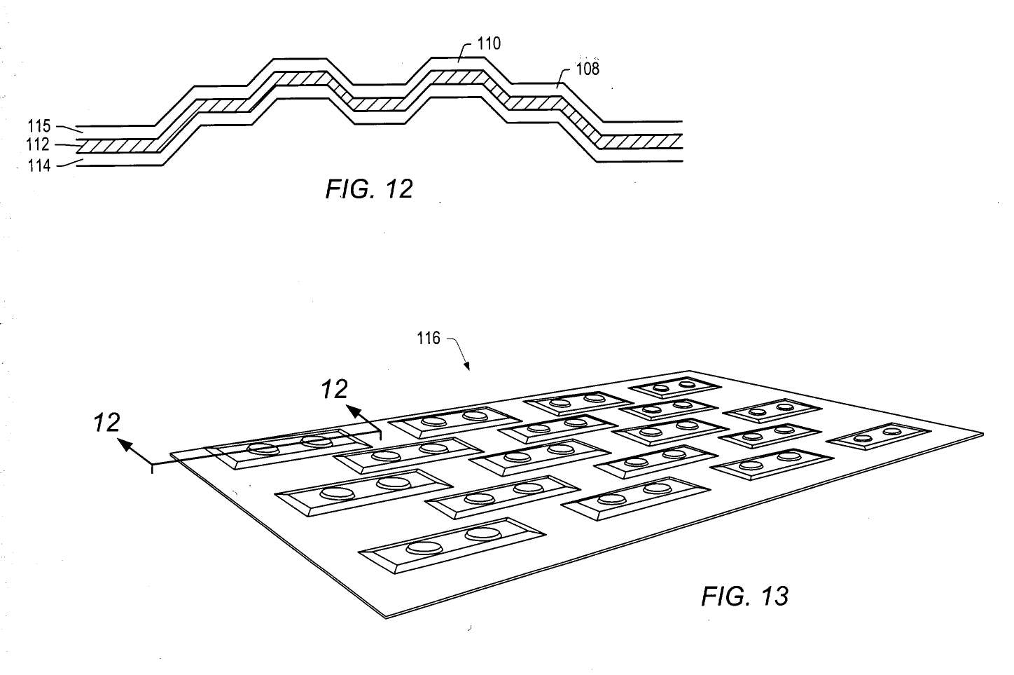

FIG. 12 depicts a cross-sectional view of base 106 of microwavable package 104 shown in FIG. 11. Base 106 may include first boss 108 and second boss 110. In some embodiments, a third boss may be formed in second boss to provide additional height for a food product above a lowermost portion of the base. Solid susceptor 62 may include thin metal film 112 disposed between electrically insulating structural backing layer 114 and polymer barrier layer 115. In an embodiment, backing layer may be 0.5 mm thick food grade paperboard, and insulating polymer barrier layer 115 may be 0.013 mm thick polyester.

Sides 56, lid 58, and flaps 60 of microwavable package 104 shown in FIG. 11 may be designed to include solid and/or patterned susceptors as desired to enhance cooking of an intended food product. In some embodiments, microwavable package 104 may be used to cook breaded or battered food products, such as breaded chicken pieces and battered fish pieces. Microwavable package 104 may also be used to cook dough products, such as pastries and cinnamon rolls. In an embodiment, French fries may be cooked from a raw state to crispness in microwavable package 104.

In certain embodiments, an embossed inset, such as solid susceptor embossed inset 116 depicted in FIG. 13, may be placed in a microwavable package with a blank base. The embossed inset may be affixed to the base of the microwavable package. Alternatively, an embossed inset may be used with a microwavable bag or pouch, or in a food compartment of a microwavable tray. An embossed inset may be of any shape or design to achieve desired cooking (e.g., crisping) of an intended food product.

A microwavable package may be designed to promote ease of packing, storing, and/or shipping. A microwavable package may be suitable for containing frozen food for sale in a retail and/or wholesale setting. Alternatively, a microwavable package may be suitable for storing prepared food at a restaurant location. A microwavable package may be wrapped and/or sealed with methods and materials known in the art (e.g., shrink wrapping with a thin plastic film) to promote integrity of the food product before use. In an embodiment, the thin plastic film may be removed before microwaving the food product.

In certain embodiments, a microwavable package may be used to contain food products that require refrigeration. In certain applications, it may be desirable to extend a shelf life of a food product under refrigerated conditions. Extending shelf life of a food product under refrigerated conditions may be achieved by flushing a container designed to hold the food product with an inert gas, such as nitrogen.

In certain embodiments, a microwavable package may be inserted into a sealable plastic container approved for microwave cooking of food. The container may be a rigid plastic container. The container may be made of polymeric material including, but not limited to, C-PET (C-polyethylene terephthalate), polyesters, and/or polyolefins. The container may be a two-piece container with a base member and a snap-on lid member. Alternatively, the container may be of a one-piece design or any other suitable design that may be flushed with inert gas and sealed tightly to inhibit entry of air. A microwavable package inserted into a plastic container may be made of various weights of food grade paperboard or paper, including, but not limited to, 24 point paperboard, 12 point paperboard, 22 pound paper, and 28 pound paper.

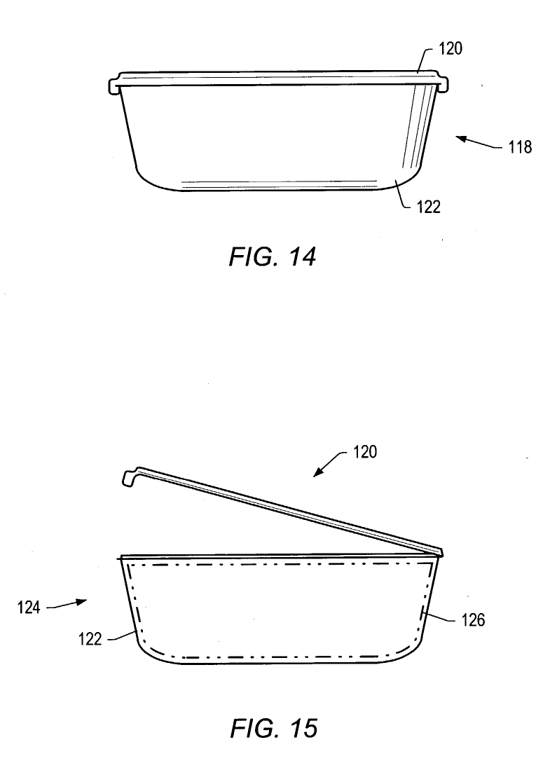

FIG. 14 depicts sealable container 118 including lid 120 and base 122. In an embodiment, a food product may be placed in a microwavable package. The microwavable package may be placed into sealable container 118 approved for microwave cooking. The food product, microwavable package, and container may then be flushed with an inert gas in an environment substantially free of oxygen. The microwavable package may be sealed, followed by sealing of the container. Lid 120 may be a snap-on lid designed to achieve a substantially air-tight seal when assembled with base 122. Alternatively, lid 120 may seal to base 122 of sealable container 118 by any method known in the art to achieve a substantially air-tight seal.

In some embodiments, a food product may be inserted into a microwavable package under inert conditions. The microwavable package may be sealed and then inserted into sealable container 118. Sealable container 118 may be flushed with an inert gas and sealed under inert conditions. Sealable container 118 may be wrapped with a plastic film to promote integrity of the food product until use.

In certain embodiments, a sealable container may include two or more components. In other embodiments, a sealable container may include a single component. FIG. 15 depicts sealable one-piece container 124 with lid 120 and base 122. Sealed microwavable package 126 is shown inside sealable container 124. Microwavable package 126 may contain a refrigerated or frozen food product. To cook the food product in microwavable package 126, sealable container 124 may be opened and placed in a microwave oven. Sealable container may provide structural support for microwavable package 126. Alternatively, microwavable package 126 may be removed from sealable container 124 before cooking.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A microwavable package for cooking a food product using microwave energy, comprising:
a lid member;
a base member;
wherein the lid member and the base member are configured to form a seal during use;
wherein an interior surface of the microwavable package comprises a patterned susceptor configured to control heat transfer and to shield the food product from incident microwave energy; and
wherein the microwavable package comprises paperboard.

2. The microwavable package of claim 1, wherein the patterned susceptor comprises a thin metal film.

3. (cancelled)

4. The microwavable package of claim 1, wherein the patterned susceptor comprises a conductive grid.

5-11. (cancelled)

12. The microwavable package of claim 1, wherein the seal allows the microwavable package to maintain a pressure above atmospheric pressure such that the food product is thermally cooked at least with heated substances evolved from the food product during cooking.

13. The microwavable package of claim 1, wherein the seal allows the microwavable package to vent above atmospheric pressure to releasing moisture from the microwavable package.

14. The microwavable package of claim 1, wherein the base member comprises double embossing.

15. The microwavable package of claim 1, wherein the food product substantially fills the microwavable package.

16-36. (cancelled)

37. A method of packaging a food product to be cooked with microwave energy, comprising:
placing the food product in a microwavable package such that the food product is adjacent to a patterned susceptor formed of a thin metal film on a first interior surface of the microwavable package, wherein the patterned susceptor shields the food product from microwave energy during microwave cooking; and
sealing the food product inside the microwavable package, wherein the microwavable package comprises paperboard.

38. The method of claim 37, wherein the patterned susceptor comprises a thin metal film.

39. (cancelled)

40. The method of claim 37, wherein the patterned susceptor comprises a conductive grid.

41. (cancelled)

42. The method of claim 37, wherein the food product substantially fills the microwavable package.

43. The method of claim 37, further comprising placing the food product in the microwavable package such that the food product is adjacent to a solid susceptor on a second interior surface of the microwavable package.

44-49. (cancelled)

50. A method of packaging a food product to be cooked with microwave energy, comprising:
placing the food product in a microwavable package, wherein the microwavable package comprises paperboard;
placing the microwavable package in a sealable microwavable container;
flushing the sealable microwavable container with inert gas; and
sealing the sealable microwavable container.

51. The method of claim 50, wherein the microwavable package comprises an embossed susceptor.

52. The method of claim 50, wherein the microwavable package comprises a solid susceptor.

53. The method of claim 50, wherein the microwavable package comprises a solid susceptor, and wherein the solid susceptor comprises a thin metal film.

54. The method of claim 50, wherein the microwavable package comprises a solid susceptor, and wherein the solid susceptor comprises a thin aluminum film.

55. The method of claim 50, wherein the microwavable package comprises a patterned susceptor.

56. The method of claim 50, wherein the microwavable package comprises a patterned susceptor, and wherein the patterned susceptor comprises a thin metal film.

57. (cancelled)

58. The method of claim 50, wherein the inert gas comprises nitrogen.

59. The method of claim 50, wherein the sealable microwavable container comprises one or more components.

60. The method of claim 50, wherein flushing the sealable microwavable container with inert gas comprises substantially removing oxygen from inside the sealable microwavable container.

61. The method of claim 50, further comprising wrapping the sealed sealable microwavable container with a thin plastic film.

62. The method of claim 50, wherein sealing the sealable microwavable container substantially inhibits air from entering the sealed container.

63. A method of cooking a food product with microwave energy, comprising:
exposing a microwavable package containing the food product to the microwave energy, wherein the microwavable package comprises paperboard; and
allowing a patterned susceptor on an interior surface of the microwavable package to shield at least some of the microwave energy from the food product.

64. The method of claim 63, wherein the patterned susceptor comprises a thin metal film.

65. (cancelled)

66. The method of claim 63, wherein the patterned susceptor comprises a conductive grid.

67. The method of claim 63, wherein the patterned susceptor comprises a grid of conductive shapes.

68. (cancelled)

69. The method of claim 63, wherein the microwavable package further comprises a solid susceptor.

70. The method of claim 63, wherein the microwavable package further comprises a solid susceptor, and wherein the solid susceptor comprises a thin metal film.

71. (cancelled)

72. (cancelled)
